(19) United States
(12) Patent Application Publication
(10) Pub. No.: US 2018/0179881 A1
(43) Pub. Date: Jun. 28, 2018

(54) SYSTEM AND METHOD FOR DETECTING STRUCTURAL INTEGRITY OF A WELL CASING

(71) Applicant: Chevron U.S.A. Inc., San Ramon, CA (US)

(72) Inventors: Melvin Clark THOMPSON, San Ramon, CA (US); James Daniel MONTOYA, San Ramon, CA (US); Jacobo Rogelio ARCHULETA, San Ramon, CA (US)

(21) Appl. No.: 15/901,217

(22) Filed: Feb. 21, 2018

Related U.S. Application Data
(63) Continuation-in-part of application No. 14/356,991, filed on May 8, 2014, now abandoned.
(60) Provisional application No. 61/777,553, filed on Mar. 12, 2013.

(51) Int. Cl. E21B 47/00; E21B 43/24; G01V 11/00

(52) U.S. Cl. CPC E21B 47/0006; E21B 47/04; G01V 11/002; E21B 43/24

(57) ABSTRACT

This disclosure relates to a system and method for detecting structural integrity of a well casing. The system may detect casing structural integrity events. The casing structural integrity events may include structural failures of the casing and/or potential structural failures of the casing. The well casing may be drilled and/or otherwise embedded into a geologic structure. The well casing may be subject to geologic forces generated by the geologic structure. Unplanned and/or unexpected forces and/or movement may pose a risk to the structural integrity of the casing. Forces and/or movement of sufficient magnitude may result in damage to and/or destruction of the casing. Damage to and/or destruction of the casing may cause a loss of the natural resources being extracted via the well associated with the well casing, contamination of areas surrounding the well, undesirable surface expression, and/or other negative effects.

The present application is a continuation in part of U.S. Utility patent application Ser. No. 14/356,991, filed May 8, 2014, entitled “System and Method for Detecting Structural Integrity of a Well Casing”; which is a national stage entry of PCT/US2014/023863, entitled “System and Method for Detecting Structural Integrity of a Well Casing”, filed Mar. 12, 2014; which in turn claims priority from U.S. Provisional Patent Application Ser. No. 61/777,553 entitled “System and Method for Detecting Structural Integrity of a Well Casing”, filed Mar. 12, 2013. The subject matter of each of these applications is incorporated by reference herein.

### FIELD OF THE DISCLOSURE

This disclosure relates to a system and method for detecting structural integrity of a well casing. The system may detect casing structural integrity events. The casing structural integrity events may include structural failures of the casing and/or potential structural failures of the casing related to the well tubing and/or other parts of the well structure.

### BACKGROUND

Systems for sensing characteristics inside a well are known. An electrical connection to a well casing and a tubing string may power a down hole gauge and/or actuator. Current systems typically include gauges and/or actuators that monitor characteristics related to the natural resources flowing through the well. The current systems do not detect structural characteristics of the well casing.

### SUMMARY

Aspects of the present disclosure relate to a system and a method for detecting structural integrity of a well casing in a well. In some implementations, the well may comprise a wellhead at a ground surface of the well and above ground extraction equipment located at or near the wellhead. The extraction equipment may be configured to extract liquid and/or gas from an underground reservoir through the wellhead. In some implementations, the well may comprise a metallic well casing configured to surround a metallic well production tubing. The tubing may be configured to communicate the liquid and/or gas from the underground reservoir to the above ground extraction equipment. The casing may be embedded in a geologic structure. In some implementations the well may include a hanger coupled to the wellhead. The hanger may be configured to suspend the tubing within the casing.

In some implementations, the system comprises one or more sensors, one or more processors, and/or other components. The one or more sensors may be configured to measure or detect physical properties of the well, and generate output signals conveying information related to a structural integrity of the casing and/or a casing-tubing pair. In some implementations, the one or more sensors may be coupled to one or more of the extraction equipment, the wellhead, the hanger, the tubing, the casing, and/or other well components. In some implementations, the information related to the structural integrity of the casing and/or the casing-tubing pair comprises information indicating a response of the tubing, the casing, the liquid, and/or the gas of the well to a stimulus generated or applied onto the well.

In some implementations, the one or more processors may be configured to detect casing structural integrity events based on the measured sensor output signals, and to generate casing structural integrity event notifications that correspond to the detected casing structural integrity events for delivery to a user. The casing structural integrity events may include one or both of structural failures of the casing or potential structural failures of the casing, for example.

In some implementations, the one or more sensors and the one or more processors may be configured such that they record or otherwise indicate physical phenomena in various stages of well operations such as pre-production phase, steam injection phase, phase operation of the well and production phase operation of the well. The one or more sensors may also record the response of active stimuli applied to the well, such as an propellant charge, an electromagnetic stimulus, a piezoelectric stimulus, a pneumatic stimulus, and/or other active stimuli. In some implementations, the sensors and one or more processors may be configured to detect physical phenomena due to wellbore structural integrity events based on a comparison of information in output signals corresponding to two or more separate indicators generated at different times within the well. In some implementations the one or more sensors may be configured such that the information in the measured signals, may correspond to the two or more separate stimuli, generated for the well comprises one or both of time histories for given output signals or frequency spectrums for the given output signals. In some implementations, the one or more sensors may be configured to detect signals for two or more separate indicators generated during either a pre-production phase or a production phase of well operation.

In some implementations, the one or more processors may be configured to detect the casing structural integrity events using an algorithm. Algorithm inputs may be supplied based on the measured sensor signals such that the casing structural integrity events are detected based on information in output signals from one or more different types of sensors. In some implementations, the algorithm inputs may comprise well parameters and corresponding parameter threshold levels determined based on the output signals. In some implementations, responsive to one or more of the well parameters breaching corresponding well parameter thresholds, output from the algorithm may indicate that a casing structural integrity event has occurred.

In some implementations, the one or more sensors may include one or more of fluid level sensors, voltage sensors, acoustic sensors, pressure sensors, temperature sensors, motion sensors, current sensors, impedance sensors, magnetic sensors, strain sensors, and/or other sensors. In some implementations, the one or more sensors include one or more hydrophones, one or more electrical impedance sensors, one or more magnetometers, one or more accelerometers, one or more strain gages, one or more pressure gages, one or more temperature gages and/or other sensors. In some implementations, a first accelerometer, a first hydrophone, and a first strain gage may be coupled to the hanger; a second accelerometer and a pressure gage may be coupled to the tubing and/or casing in the well below the hanger; and a second hydrophone, a third accelerometer, and a magnetometer may be coupled to the wellhead and/or the extraction equipment. In some implementations, the one or more sensors may be configured such that the response is an acoustic response, and the one or more processors may be configured such that casing structural integrity events are determined based on a speed of sound caused by the stimulus through one or more of the tubing, the casing, the liquid, or the gas.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to detect structural integrity of a well casing.

FIG. 2 illustrates various sensors in three views of a wellhead and extraction equipment of a well.

FIG. 3 illustrates various locations for sensors and/or components associated with the sensors in three views of the wellhead, a hanger, tube, and/or a casing of the well.

FIG. 4 illustrates an example configuration of multiple sensors.

FIG. 5 illustrates an example stimulus generated for the well.

FIG. 6 illustrates accelerations detected in response to a stimulus occurring at a given depth within the well.

FIG. 7 illustrates the acceleration response for different components and/or at different depths in the well to the same stimulus for a well with structural integrity defects.

FIG. 8 illustrates pressure and frequency spectrum variation detected in response to a stimulus occurring within the casing of the well.

FIG. 9 illustrates the pressure and frequency spectrum variation detected in response to the same stimulus for a well with structural integrity defects.

FIG. 10 illustrates an acceleration time history and a dynamic pressure time history for a producing well.

FIG. 11 illustrates a natural resource field that includes multiple wells.

FIG. 12 illustrates a method for detecting structural integrity of a well casing.

FIG. 13 illustrates another method for detecting structural integrity of the well casing.

### DETAILED DESCRIPTION

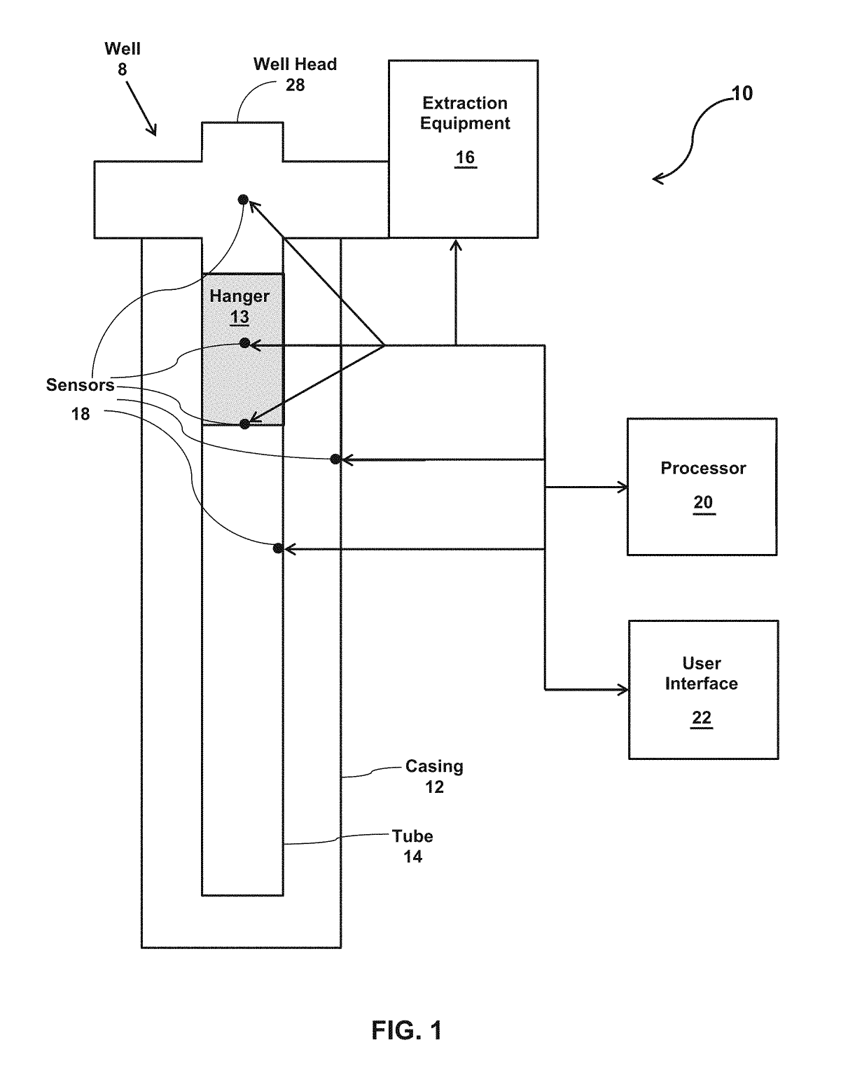

FIG. 1 illustrates a system 10 configured to detect structural integrity of a well casing 12 in a well 8. Well 8 may be configured to extract material (e.g., minerals, gasses, oil, water, etc.) from an underground reservoir. During extraction, well 8 may be configured to communicate liquid and/or gas from the underground reservoir to above ground extraction equipment 16 at or near a wellhead 28. Well 8 may be drilled and/or otherwise embedded into a geologic structure. Well 8 may be subject to geologic forces generated by the geologic structure. Unplanned and/or unexpected forces and/or movement may pose a risk to the structural integrity of casing 12. Forces and/or movement of sufficient magnitude may result in damage to and/or destruction of casing 12. Damage to and/or destruction of casing 12 may cause a loss of the natural resources being extracted via well 8, contamination of areas surrounding well 8, undesirable surface expression, and/or other negative effects.

System 10 may be configured to detect casing structural integrity events and generate casing structural integrity event notifications that correspond to the detected casing structural integrity events. The casing structural integrity events may include structural failures of casing 12 and/or tube 14, potential structural failures of casing 12 and/or tube 14, and/or other events. By way of a non-limiting example, many casing failures in the oil industry occur in steam injection wells, and are considered high risk. Phases of cyclic steam stimulation include injection, soaking, flow-back and pumping. The cyclically applied steam injection process causes cyclic elevated temperatures to exist, and as such thermally-induced fatigue failure of wellbore components. Casing failure typically occurs due to high thermal axial forces within the casing, and external pressure from radial expansions and formation loading. These resulting ID restrictions are due to casing collapse, buckling, parting, holes, and cracks. Once the casing is breached, steam can be inadvertently and unknowingly be injected to unwanted locations along the wellbore, and can potentially reach the surface causing dangerous and life threatening scenarios, such as sinkholes. By proactive monitoring the wellbore health, these potentially dangerous situations can be mitigated. In some implementations, system 10 may comprise casing 12, tube 14, a hanger 13, extraction equipment 16, one or more sensors 18, one or more processors 20, user interface 22, wellhead 28, and/or other components.

Casing 12 may surround tube 14, sensors 18, and/or other components of system 10. Casing 12 may line the borehole and provide structural support for well 8. Casing 12 may separate well 8 from the geologic structure. The geologic structure may include subsurface materials (e.g., rocks, dirt, etc.), water (e.g., in the case of a well in the ocean floor), and/or other environmental materials. Casing 12 may be made from a conductive material such as steel and/or other materials.

Tube 14 may be configured to communicate liquid and/or gas during mineral extraction. Tube 14 may be configured to communicate liquid and/or gas from the underground reservoir to above ground extraction equipment 16 at or near wellhead 28. In some implementations, tube 14 may be a tubing string. The tubing string may include a series of coupled tubes. The series of tubes may be coupled via threaded ends of each tube and/or other coupling mechanisms. In some implementations, the series of coupled tubes may be a series of coupled tubing joints. The joints may include, for example, a pup joint. Tube 14 may be made from electrically conductive materials such as steel and/or other electrically conductive materials.

As described above, tube 14 may be provided within casing 12. Providing tube 14 within casing 12 may create an inner annular space between the outer surface of tube 14 and an inner surface of casing 12. One or more centralizers may be configured to maintain tube 14 in the annular space to maintain a physical separation between tube 14 and casing 12. The centralizers may couple with the outside diameter of tube 14 via one or more coupling devices. The coupling devices may include, for example, a clamp, a collar, a latch, a hook, adhesive, and/or other coupling devices. The centralizers may be configured to engage casing 12 at various locations in well 8 to maintain a physical separation between tube 14 and casing 12. The centralizers may include, for example, bow spring centralizers, floating collars, fixed position devices, mixed dielectric centralizers, and/or other centralizers. In some implementations, the centralizers may be made from one or more conductive materials such as steel and/or other materials. In some implementations, the centralizers may be made from non-conductive materials.

In some implementations, tube 14 may cooperate with casing 12 to form a coaxial transmission line. One or more electrical loads (e.g., sensors 18) disposed within well 8 may be powered via the coaxial transmission line formed by casing 12 and tube 14 without the need for electrical wiring (though in some implementations sensors 18 may include associated wiring). Casing 12 and tube 14 may be configured such that voltage and/or current across casing 12 and tube 14 are sufficient to power the electrical load(s). In some implementations, tube 14 may have a positive polarity and casing 12 may have a negative polarity. In some implementations, an electrical load may be electrically coupled with the electrically positive tube 14 and separately with the electrically negative casing 12 such that the load is powered via the connections. In other implementations, single or two-way data communication can be transmitted acoustically through the drill string or casing.

Wellhead 28 may be located at or near a ground surface of well 8. For example, wellhead 28 may be located at the ground surface where the wellbore of well 8 terminates. Wellhead 28 may be and/or include structural support for well 8, a pressure-control interface (e.g., including spools, valves, adapters, etc.) for well 8, components for coupling with hanger 13 and/or facilitating the hanging of tube 14, and/or other components. Wellhead 28 may be configured to suspend tube 14 and/or casing 12 in well 8. Wellhead 28 may be a structural interface between tube 14 and extraction equipment 16 configured to couple tube 14 with extraction equipment 16. Wellhead 28 may be configured to contain pressure present in well 8. Wellhead 28 may be configured to provide physical access to well 8 including access to annular space(s) between casing 12 and/or tube 14. Wellhead 28 may be configured to provide electrical ports that are electrically coupled with tube 14, casing 12, sensors 18, and/or other components of system 10.

Hanger 13 may be coupled to wellhead 28 and configured to suspend tube 14 within casing 12. In some implementations, hanger 13 comprises a sealing mechanism configured to hydraulically isolate tube 14 from casing 12 and/or other components of well 8.

Extraction equipment 16 may be configured to extract liquid and/or gas from an underground reservoir through tube 14, wellhead 28, and/or other components of well 8. Extraction equipment 16 may be and/or include various motors, pumps, valves, conduits, gages, and/or other components configured to facilitate gas and/or fluid (e.g., oil, natural gas, water, etc.) extraction from well 8. In some implementations, extraction equipment 16 may include equipment configured to manage operation of well 8. Managing the operation of well 8 may include drawing liquid and/or gas through well 8, storing the liquid and/or gas, monitoring well 8, powering well 8, preparing well 8 for production, analyzing data related to the operation of well 8, and/or other activities. Such equipment may include pumps, piping, wiring, liquid and/or gas storage devices, power supplies, data processing equipment (e.g., one or more computers and/or processors), communication equipment, cameras, safety systems, well control devices, and/or other extraction equipment. For example, a well power supply may be configured to supply a positive polarity to tube 14 and a negative polarity to casing 12. As another example, user interface 22 (described below) may be provided by extraction equipment 16.

Extraction equipment 16, sensors 18, processor 20, user interface 22, and/or other components of system 10 may be operatively linked via one or more electronic communication links. Such electronic communication links may be wired and/or wireless. For example, such electronic communication links may be established, at least in part, via a network and/or other links. In some implementations, extraction equipment 16, sensors 18, processor 20, and/or user interface 22, may be configured to communicate directly. It will be appreciated that this is not intended to be limiting, and that the scope of this disclosure includes implementations in which extraction equipment 16, sensors 18, processor 20, user interface 22, and/or other components of system 10 may be operatively linked via some other communication media, or with linkages not shown in FIG. 1.

Sensors 18 may be configured to generate, measure, and/or record output signals conveying information related to the structural integrity of casing 12. The output signals may include output signals related to the casing, the tubing, the casing-tubing pair, and/or other components of well 8. The information related to the structural integrity of casing 12 may comprise information related to structural failures of casing 12, information related to potential structural failures of casing 12, and/or other information. The information related to structural failures and/or the potential structural failures may include information related to movement of and/or physical changes in casing 12, tube 14, and/or other components of well 8. The information related to structural failures and/or the potential structural failures may include information related to physical defects and/or a potential for physical defects in casing 12. The physical defects may include, for example, breaks, cracks, holes, deformations, loss of centralization, and/or other defects. Sensors 18 may comprise one or more sensors that measure such information directly (e.g., through direct contact with casing 12). In some implementations, sensors 18 may comprise one or more sensors that generate output signals related to the structural integrity of casing 12 indirectly. For example, one or more of sensors 18 may generate an output based on a characteristic of tube 14 (e.g., an amount of electrical current running through tube 14), based on a characteristic of the liquid and/or gas in tube 14 (e.g., a fluid level), based on sound waves that pass through and/or are reflected by one or more components of and/or liquid and/or gas in well 8, based on geological movement at or near the surface of well 8 and/or surrounding casing 12, based on an electrical impedance of one or more components of well 8, based on changes in a magnetic field in and/or around well 8, based on pressure changes of the liquid and/or gas in well 8, based on an intensity and/or direction of vibrations (e.g., accelerations) of one or more components of well 8, and/or other information.

In some implementations, sensors 18 may include a single sensor type. In some implementations, sensors 18 may include two or more different sensor types. Sensors 18 may include, for example, fluid level sensors, voltage sensors, acoustic sensors, pressure sensors, temperature sensors motion sensors, current sensors, strain sensors, impedance sensors, force sensors, flow sensors, composition sensors, temperature sensors, magnetic sensors, and/or other sensors. For example, sensors 18 may include one or more hydrophones, one or more electrical impedance sensors, one or more magnetometers, one or more accelerometers, one or more strain gages, one or more pressure gages, and/or one or more other sensors.

As an example of an implementation of the present system with several different types of sensors 18, fluid level sensors may generate output signals conveying information related to a fluid level in well 8. In some implementations, the fluid level information may be indicative of casing 12 collapse, pressure in the casing, sheer forces acting on the casing and/or other components, an electrical short between tubing 14 and casing 12, an open breach of the wall of casing 12, and/or other phenomena. A current sensor (e.g., a transformer) on tube 14 may generate output signals conveying information related to voltage and/or current changes in an otherwise closed circuit (e.g., due to movement, damage, etc.). This could be multiplexed in more than one mode (sourced or passive). The passive mode may behave like a voltage and/or current receiver. The voltage and/or current sensors may be located just below a tubing hanger 13, for example. An acoustic sensor (e.g., an accelerometer and/or a microphone) may be mounted to tube 14, hanger 13, in and/or near wellhead 28, and/or at other locations. The spectral character of the monitored sound may include mechanical motion and/or resonance information related to the structural integrity of casing 12. One or more pressure and/or temperature sensors mounted in well 8 (e.g., in the annular space between tube 14 and casing 12, within tube 14, etc.) may convey information related to the pressure in those areas of well 8, and/or the stability of those pressures. For example, an unstable pressure may indicate that a structural integrity event has occurred and/or is about to occur. A motion sensor (e.g., an accelerometer) may generate output signals related to movement of casing 12, tube 14, and/or other components of well 8. Strain gages affixed to tube 14 may generate output signals conveying information related to internal stresses and/or strains.

In some implementations, sensors 18 may be configured to passively monitor well 8. Passively monitoring well 8 may comprise generating and/or recording the output data signals in an ongoing manner regardless of which production phase well 8 is in and/or other factors related to the operation of well 8. This ongoing data may be recorded and compared for several wells, and/or archived for a normal operations baseline. When an off-normal condition for a particular production phase is recorded in the data stream, an algorithm can be implemented that notifies the user of the anomaly, and further investigative action can be taken on that particular well or wells. In some implementations, sensors 18 may be configured to monitor the response of an active stimulus that is applied to one or more components of well 8. The active stimulus can be applied, for example, at the well casing. For example, a mechanical stress wave can be propagated downhole along the conductive casing or tubing string. The response of this applied stimulus can be recorded and compared to baseline data and theoretical solution responses. When an off-normal response for a particular production phase is recorded in the data stream, an algorithm can be implemented that notifies the user of the anomaly, and further investigative action can be taken on that particular well or wells. In such implementations, the information related to the structural integrity of tube 14, casing 12, and/or the casing-tubing pair may comprise information indicating a response of tube 14, casing 12, the liquid, and/or the gas of well 8 to the stimulus generated for well 8. In some implementations, the stimulus may comprise, of a propellant charge, an electromagnetic stimulus, a pneumatic stimulus, piezoelectric stimulus, and/or other stimuli.

In some implementations, sensors 18 may be configured such that the information in the output signals corresponding to stimuli generated for the well comprises one or both of time histories for given output signals, frequency spectrums for the given output signals, and/or other information. For example, sensors 18 may be configured to measure and/or generate output signals that include information related to a fluid level over time (e.g., a time history) after a given stimulus, a voltage and/or other electrical parameters over time after the given stimulus, an acoustic parameter (e.g., frequency spectra, power, propagation speed, etc.) over time after the given stimulus, a pressure in well 8 over time after the given stimulus, a motion parameter (e.g., an acceleration) over time after the given stimulus, a magnetic parameter (e.g., a magnetic flux associated with well 8) over time after the given stimulus, an impedance parameter over time after the given stimulus, a strain level over time after the given stimulus, and/or other information. In general, the frequency spectrums of the output signals comprise a distribution of amplitudes, phases, and/other characteristics of individual frequency components (e.g., portions of the frequency spectrum). In some implementations, frequency spectra for the given output signals comprise or describe the power distribution of a signal by discretizing the frequency components of that signal transmitted by a system, in this case the wellbore. By gathering historical data by various sensors and forming a baseline power spectra of wellbore, an off-normal event, such as a casing failure, can be discerned, by an algorithm, from normal wellbore operations triggering further investigative actions.

Sensors 18 are illustrated in FIG. 1 and described above at various locations within system 10. Sensors 18 may be coupled to one or more of extraction equipment 16, wellhead 28, hanger 13, tubing 14, casing 12, and/or other components of well 8. In some implementations, at least one of sensors 18 may be electrically coupled with tube 14 and casing 12 separately. At least one of sensors 18 may be located in wellhead 28. Sensors 18 may be located at one or more locations along tube 14 within casing 12. In some implementations, one or more of the sensors may communicate via tube 14. Sensors 18 may be located within casing 12 at or near tubing hanger 13 between wellhead 28 and tube 14. By way of a non-limiting example arrangement of such sensors, in some implementations, a first accelerometer, a first hydrophone, and a first strain gage may be coupled to hanger 13; a second accelerometer and a pressure and temperature gage may be coupled to tubing 14 and/or casing 12 in well 8 below hanger 13; and a second hydrophone, a third accelerometer, and a magnetometer may be coupled to wellhead 28 and/or extraction equipment 16.

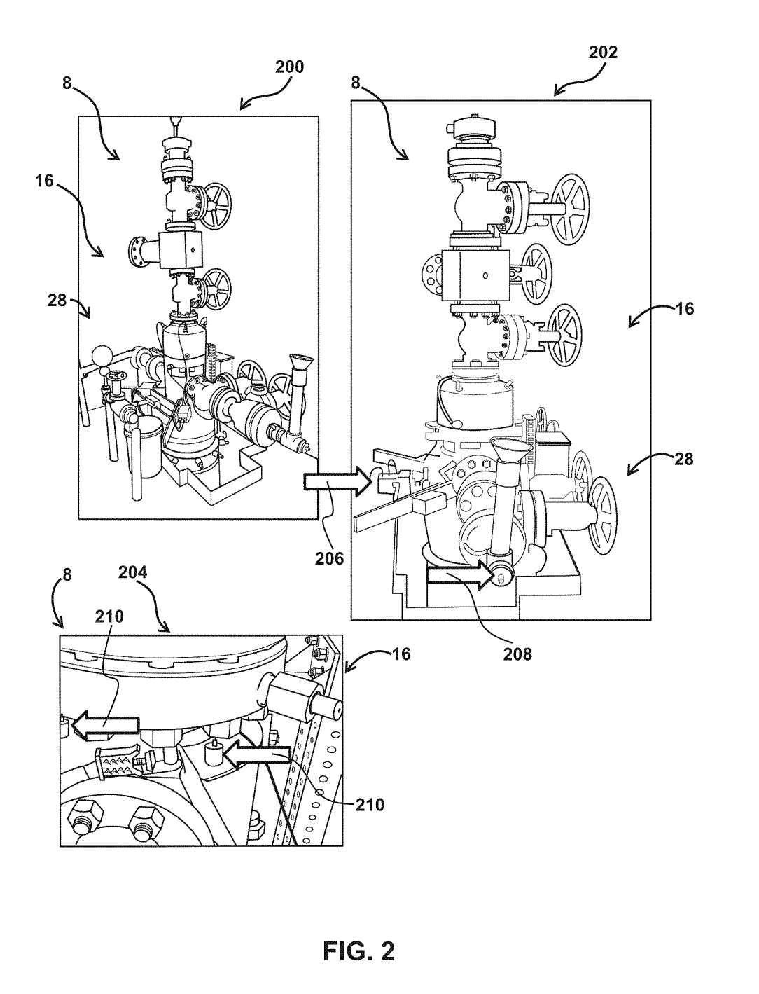

For example, FIG. 2 illustrates various sensors in three views 200, 202, and 204 of wellhead 28 and extraction equipment 16 of well 8. View 202 and 204 are increasingly enlarged views of view 200. As shown in view 202, a magnetometer 206 and a hydrophone 208 are coupled with extraction equipment 16 at wellhead 28. As shown in view 204, an accelerometer assembly 210 is also coupled with extraction equipment 16 at wellhead 28. In some implementations, magnetometer 206, hydrophone 208, and accelerometer assembly 210 are coupled to extraction equipment 16 at wellhead 28 via various coupling mechanisms including clamps, straps, screws, nuts, bolts, spacers, adhesive, mounting platforms, and/or other coupling mechanisms.

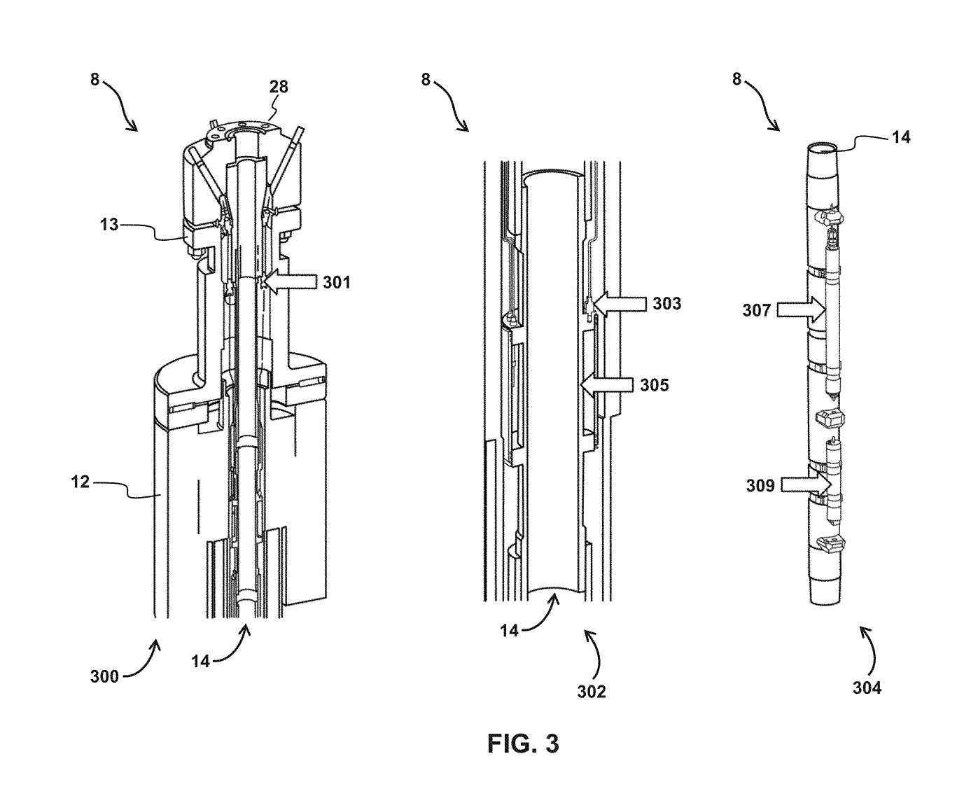

As another example, FIG. 3 illustrates various locations 301, 303, 305, 307, and 309 for sensors 18 and/or components associated with sensors 18 (illustrated in FIG. 1) in three views 300, 302, and 304 of wellhead 28, hanger 13, tube 14, and/or casing 12 of well 8. View 300 is a cross-sectional view of wellhead 28, hanger 13, tube 14, and casing 12 in well 8. Location 301 shows hermetically sealed electrical feed-throughs intended to seal the wellbore from the surface and facilitate electrical signal transmission via wires and cables from the various internal wellbore sensors. View 302 is an enlarged view of the cross section of tube 14. View 304 illustrates a view of a fully enclosed portion tube 14. In this example, hanger assembly 13 may be coupled with an accelerometer, a hydrophone, a strain gage, and/or other sensors 18. Reference numeral 301 illustrates a possible location for one or more of these sensors as well as one or more components associated with sensors 18 configured to facilitate communication of output signals from sensors 18 (e.g., electrical connection components, wiring, a centralizer as described above, etc.) In some implementations, one or more of these sensors may be combined in a lower sub-surface assembly unit and coupled to hanger 13, tube 12, casing 14, and/or other components of well 8. View 302 illustrates a sealed housing formed at location 305 configured to house one or more of these sensors and/or such a sub-surface assembly unit. The sealed housing 305 is intended for attachment of sensors and electrical equipment required to be separated from wellbore fluids. For example, in view 302, strain gages, amplifiers, piezoelectric films, and cables can be included within a sub-surface assembly unit located at location 305. This housing may be and/or be formed by a centralizer and/or other components of well 8, for example. As shown at location 303, the housing may be coupled with and/or located proximate to one or more components associated with sensors 18 configured to facilitate communication of output signals from sensors 18. View 304 illustrates another possible sensor arrangement example located within the wellbore, some distance from the surface. In view 304, an accelerometer and amplifier assembly may be located, within a sealed housing, at location 307, and similarly, a high temperature and high pressure gage may be located at location 309, within a sealed housing. It should be noted that the example sensor configuration shown in FIG. 3 is not intended to be limiting. Many similar sensor arrangements are contemplated.

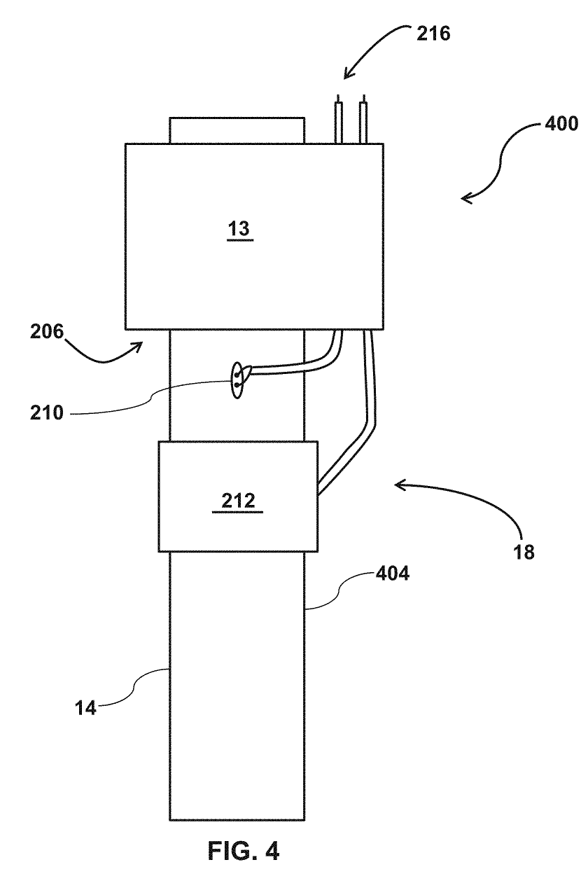

As another example, FIG. 4 illustrates yet another possible configuration of multiple sensors 18. In FIG. 4, a sensor assembly 400 may be packaged as a small “launcher” on a four foot sub 404. The sensors shown in FIG. 4 are examples of the sensors that may be included in such an assembly and are not intended to be limiting. Assembly 400 may include other sensors not shown in FIG. 4. The sensors shown in FIG. 4 include a strain sensor 410 (e.g., a strain gauge) and a current sensor 412. The voltage sensor may include, for example, an RF/AC transformer coupled current monitor including a magnetic core on tube 14. Assembly 400 may be compactly located at or near an underside 406 of tubing hanger 13. In some implementations, assembly 400 (and/or the sensors and/or sensor assemblies described above related to other figures) may include feed-thru capability in hanger 13 for wire leads 416. In some implementations, an acoustic transducer (not shown in FIG. 4) may be mounted on the top of hanger 13 and/or in other locations. In some implementations, the transducer may be thermally isolated and/or have other characteristics. The collective electronics for assembly 400 (and/or the sensors and/or assemblies described above related to other figures) may be packaged in a small enclosure. In some implementations, sensor assembly 400 (and/or the sensors and/or sensor assemblies described above related to other figures) may be powered by a battery, solar power, and/or other power sources/supplies. In some implementations, sensor assembly 400 (and/or the sensors and/or sensor assemblies described above related to other figures) may require a relatively low amount of power. For example, sensor assembly 400 may require about 5 to 10 watts. In some implementations, sensor assembly 400 (and/or the sensors and/or sensor assemblies described above related to other figures) may include power management and RF source generation circuitry not shown in FIG. 4.

Sensors 18 may include sensors disposed in a plurality of alternate locations in addition to and/or instead of those shown in FIG. 1-4. In some implementations, tube 14, casing 12, a conductive centralizer, and/or other components of well 8 may be configured to provide a signal path for the output signals (as described herein). In some implementations, one or more sensors 18 may communicate output signals wirelessly via a network such as the internet and/or other wireless communication methods.

Returning to FIG. 1, processor 20 may be configured to provide information processing capabilities in system 10. As such, processor 20 may include one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some implementations, processor 20 may include a plurality of processing units. These processing units may be physically located within the same device, or processor 20 may represent processing functionality of a plurality of devices operating in coordination. Processor 20 may be configured to execute one or more computer program modules. Individual ones the computer program modules may be configured to provide at least a portion of the functionality attributed herein to processor 20. Processor 20 may be configured to execute the one or more computer program modules by software; hardware; firmware; some combination of software, hardware, and/or firmware; and/or other mechanisms for configuring processing capabilities on processor 20. It should be appreciated that the modules may be co-located within a single processing unit, and/or one or more of the modules may be located remotely from the other modules. In some implementations, processor 20 may be integrated with extraction equipment 16, user interface 22, and/or other components of system 10.

Processor 20 may be configured to detect casing structural integrity events based on the output signals from sensors 18 and/or other information. In some implementations, the casing structural integrity events may include structural failures of the casing, potential structural failures of the casing, and/or other casing structure failure events. The casing structural integrity events may be detected responsive to one or more forces acting on casing 12. The one or more forces may include a shear force, a tensile force, a compressive force, a torsional force, and/or other forces. The one or more forces may be generated by the geologic structure surrounding casing 12, by operation of well 8 (e.g., fluid flowing through well 8, stopping and starting operation of well 8, etc.), and/or have other sources. For example, geologic layers and/or strata may shift on each other creating shear forces that act on casing 12. As another example, sudden forces caused by starting and/or stopping operation of well 8 one or more times may cause forces that act on one or more components of well 8. Processor 20 may be configured to generate casing structural integrity event notifications that correspond to the detected casing structural integrity events. The casing structural integrity event notifications may be generated for delivery to a user responsive to the detections. Processor 20 may be configured to control user interface 22 to display the notifications generated by processor 20, text and/or email a notification to a remote user, and/or facilitate display of the notifications on a web page, for example. These examples are not intended to be limiting.

In some implementations, processor 20 may be configured to detect casing structural integrity events based on the output signals from a single type of sensors 18 (e.g., acoustic sensors such as hydrophones). In some implementations, processor 20 may be configured to detect casing structural integrity events based on the output signals from at two or more different types of sensors 18 (e.g., hydrophones, accelerometers, pressure sensors, temperature sensors strain gages, and magnetometers). Processor 20 may be configured to process the information conveyed by the output signals of the one or more different types of sensors to detect casing structural integrity events. For example, processor 20 may be configured such that processing the information includes determining baseline well information, determining extraction parameters that indicate whether well 8 is operating in a pre-production or a production phase, determining well parameters that characterize a current physical condition of well 8, detecting casing structural integrity events based on an algorithm, detecting casing structural integrity events by clustering the information conveyed by the output signals in a multidimensional space, determining a casing structural integrity score and/or other metrics related to casing structural integrity, monitoring change in the determined parameters (e.g., rate of change, standard deviation, and/or other measurements of change), determining extraction and/or well parameter thresholds and comparing the extraction and/or well parameters to their corresponding thresholds, and/or other information processing. In some implementations, processing the information may include determining other information based on an integration and/or conglomeration of the information conveyed by the output signals.

The extraction parameters may include information indicating whether the well is operating in a production phase, a pre-production phase, and/or other phases. For example, the extraction parameters may include parameters related to whether or not liquid and/or gas is actively flowing through tube 14. In some implementations, extraction parameters include a flow rate of liquid or gas through tube 14, an amount or character of acoustic signature produced by well 8, a pressure in well 8, an amount of movement and/or vibration in well 8, a magnetic field associated with well 8, and/or other extraction parameters. Additional parameters could include, for steam injection wells for example, the determination of steam mass flow rate at the inlet of the well, and at downhole formation locations. Sensors that determine the steam parameters such as velocity, temperature, pressure, specific volume, at these locations can yield the mass flow rate of the steam. By comparison of the flowrate parameters at the surface (inlet) and formation (outlet), and from fluid dynamics conditions that the inlet flowrate must equal the outlet flowrate, less there is an intermediate junction between the two locations, can yield information on leaks and/or full casing breach. A fully understood mass flowrate at the two locations may not need to be realized, as long-term monitoring of certain parameters of the flow, such as temperature, pressure, or acoustics may yield information on well integrity. Monitoring of these basic parameters over time will yield a baseline, steady-state normal operation, or modus operandi of the well. When an off-normal condition, such as a temperature or pressure fluctuation, or acoustic signature change is detected by the sensor array and processed by the algorithm and processing hardware, the user is notified by the monitoring system, and further investigative action can be taken on that particular well or wells.

The well parameters may characterize a current physical condition of well 8. In some implementations, the well parameters may be similar to and/or the same as the extraction parameters. The one or more well parameters may include, for example, a fluid level, a voltage and/or other electrical parameters, an acoustic parameter, a pressure, a motion parameter, a magnetic parameter, an acceleration parameter, an impedance parameter, a strain level, and/or other parameters. In some implementations, the determined parameters (e.g., extraction and/or well) may be numerical representations of the output (electrical) signals from sensors 18. The output (electronic) signals from such sensors may comprise a varying voltage, for example, wherein the output voltage is proportional to the parameter being measured. For example, the output voltage of a temperature sensor (which may be amplified, etc.) is proportional to the measured temperature. Processor 20 may be programmed to convert the varying voltage into a numerical representation of a particular parameter (e.g., to determine the parameter based on the output signal). In some implementations, processor 20 may be programmed to convert the electronic information into a visual representation of the electronic information (e.g., a number displayed via user interface 22).

In some implementations, processor 20 may be configured to monitor change in the determined (e.g., extraction and/or well) parameters. Monitoring change may include, analyzing the determined parameters, comparing currently determined parameters to previously determined parameters, generating one or more graphics showing change in a given parameter over time, and/or other monitoring. For example, processor 20 may be configured to analyze the determined parameters by determining a rate of change, a standard deviation, a moving average, and/or other determinations representative of change for a given parameter. Processor 20 may be configured to generate a two dimensional graph showing a level of a given parameter over time. Change may be monitored based on various increments of time. Change may be monitored on a yearly basis, a monthly basis, a weekly basis, a daily basis, an hourly basis, a minute by minute basis, a second by second basis, and/or based on other increments of time. For example, a current pressure may be compared to a previous pressure that was determined one second prior to the current pressure. A current amount of strain may be represented on a two dimensional graph with prior strain levels determined one day, one week, one month, and one year prior to the current strain level. A current acoustic signature spectrum may be compared with acoustic signature spectra determined one day, one week, one month, and one year prior to the current acoustic signature spectrum. There are several other examples associated with these and other types of sensors.

In some implementations, processor 20 may be configured to determine well parameter threshold levels (e.g., extraction and/or well parameter thresholds), and to detect the casing structural integrity events responsive to the well parameters breaching the well parameter threshold levels for a particular production level of well 8. For example, a first casing structural integrity event may be detected responsive to a first well parameter breaching a first well parameter threshold level while 8 is in a pre-production or a production phase. As a second example, a second casing structural integrity event may be detected responsive to the first well parameter breaching the first well parameter threshold level and a second well parameter breaching a second well parameter threshold level for that pre-production or production phase. Processor 20 may be configured to detect casing structural integrity events based on any number well parameters breaching any number of well parameter threshold levels for a given production phase. For example, processor 20 may detect a casing structural integrity event responsive to six different well parameters breaching six corresponding well parameter threshold levels. In some implementations, the extraction and/or well parameter threshold levels may be determined at manufacture, programmed, adjusted, uploaded, and/or updated by a user via user interface 22, and/or determined by other methods.

In some implementations, determining the extraction and/or well parameters and/or corresponding thresholds may include determining baseline well information indicating normal operation of well 8 for a given pre-production or production phase. The information that indicates normal operation of well 8 may be determined by, for example, monitoring and evaluating multiple wells during various seasons of the year, at various production levels, and/or in various geographic locations. In some implementations, processor 20 may be configured such that determining baseline well information may include determining extraction parameters. As described above, the extraction parameters may include information indicating whether the well is operating in a production phase, a pre-production phase, and/or other phases. The extraction parameters may include parameters related to whether or not liquid and/or gas is actively flowing through tube 14. In some implementations, the baseline well information for normal operation of well 8 during the pre-production phase may be different than during the production phase.

One or more extraction parameters may have a first typical level and/or range during a preproduction phase and a second typical level and/or range that is higher or lower during a production phase. By way of a non-limiting example, a flow rate of liquid or gas through tube 14, an amount or character of acoustic signature produced by well 8, a pressure in well 8, an amount of movement and/or vibration in well 8, a magnetic field associated with well 8, and/or other extraction parameters may have different baseline levels for a pre-production phase compared to a production phase in well 8. In some implementations, processor 20 may be configured to determine whether well 8 is operating in a production or pre-production phase by comparing one or more of the extraction parameters to corresponding extraction parameter thresholds and/or ranges that distinguish between production and preproduction phases of well 8. The extraction parameter thresholds and/or ranges may be determined at manufacture, programmed, adjusted, uploaded, and/or updated by a user via user interface 22, determined based on the output signals (e.g., set to level one or more standard deviations around a moving average), and/or determined by other methods.

In some implementations, processor 20 may be configured such that well parameter levels (and corresponding thresholds) that indicate a casing structural integrity event are different for a well in a pre-production phase compared to a well in a production phase. This means that processor 20 may be configured to detect the casing structural integrity events based on the extraction parameters, the well parameters, and/or other parameters. For example, processor 20 may be configured to determine that well 8 is in a pre-production phase (or conversely a production phase) based on the output signals, the corresponding extraction parameters determined based on the output signals, and the corresponding extraction parameter thresholds and/or ranges. Processor 20 may subsequently and/or concurrently determine one or more well parameters based on the output signals that characterize a current physical condition of the well. Processor 20 may determine one or more well parameter production phase and one or more pre-production phase threshold levels (e.g., because well parameter levels that indicate a casing structural integrity event are different for a well in a pre-production phase compare to a well in a production phase). Processor 20 may detect casing structural integrity events based on the output signals, the extraction parameters, the well parameters, and the corresponding threshold levels responsive to: one or more of the well parameters breaching one or more of the pre-production phase threshold levels while the well is in the pre-production phase and/or; one or more of the well parameters breaching one or more of the production phase threshold levels while the well is in the production phase.

In some implementations, processor 20 may be configured to detect the casing structural integrity events based on a comparison of information in output signals corresponding to responses of one or more of the components of well 8 to two or more separate stimuli generated at different times for well 8. In some implementations, processor 20 may be configured to compare response information in the output signals for two or more separate stimuli generated during either a pre-production phase or a production phase of well operation. A stimulus may be an event intended to evoke a response from one or more components of well 8. The event may be and/or include mechanical forces applied to well 8, electrical signals applied to well 8, acoustics projected into well 8, magnetic stimuli, pneumatic stimuli (e.g., a liquid and/or gas pressure pulse projected into well 8), and/or other stimuli. In some implementations, such stimuli may be provided by and/or include pre-production phase operation of well 8 and/or production phase operation of well 8, injecting a flow of steam into well 8, and/or other well operations. In some implementations, a stimulus may be an propellant charge, intentional vibration of one or more components of well 8, projecting sounds, an electromagnetic stimulus, a pneumatic stimulus, an electromechanical stimulus, and/or other stimuli into well 8, and/or other stimuli.

In some implementations, processor 20 may be configured to compare one or both of time histories for given output signals, frequency spectrums for the given output signals, and/or other information responsive to the stimuli. As described above, output signals from sensors 18 may include information related to a fluid level over time (e.g., a time history) after a given stimulus, a voltage and/or other electrical parameters over time after the given stimulus, an acoustic parameter (e.g., acoustic signature spectra, volume, etc.) over time after the given stimulus, a pressure in well 8 over time after the given stimulus, a motion parameter (e.g., an acceleration) over time after the given stimulus, a magnetic parameter (e.g., a magnetic flux associated with well 8) over time after the given stimulus, an impedance parameter over time after the given stimulus, a strain level over time after the given stimulus, and/or other information.

By way of a non-limiting example, in some implementations, a stimulus may be an acoustic stimulus, and the response of components of well 8 to a stimulus may be an acoustic response. Processor 20 may be configured to compare currently determined information such as the spectral character of current well acoustic signature in response to the stimulus, with previously determined information such as the normal spectral character of well acoustic signature during pre-production and/or production operations (e.g., whichever is appropriate) and/or the normal spectral character of well acoustic signature responsive to the same stimulus. Analogously, processor 20 may be configured to compare an echo or reflection produced by one or more well components, accelerations in one or more well components, variations in a magnetic field, variations in pressure, etc., caused by the stimulus.

In some implementations, processor 20 may be configured to determine a response time of one or more components of well 8 to the acoustic stimulus and/or other stimuli. In some implementations, processor 20 may be configured to compare response times corresponding to two or more stimuli, and detect structural integrity events based on differences in response times. After a stimulus is provided to well 8, sensors 18 located at various locations (e.g., various depths, coupled to various well components, etc.) may generate output signals that convey an amount of time elapsed since the stimulus was generated. In some implementations, processor 20 may be configured to determine the responses at the various locations based on the speed of sound (e.g., in response to an acoustic stimulus) through given mediums (e.g., water, oil, gas, air, steel, concrete, etc.). In some implementations, processor 20 may be configured to compare the response of well 8 at a given location over time in response to the same repeated stimulus. Differences in a response at a given location, and/or a combination of locations, may indicate a structural integrity event.

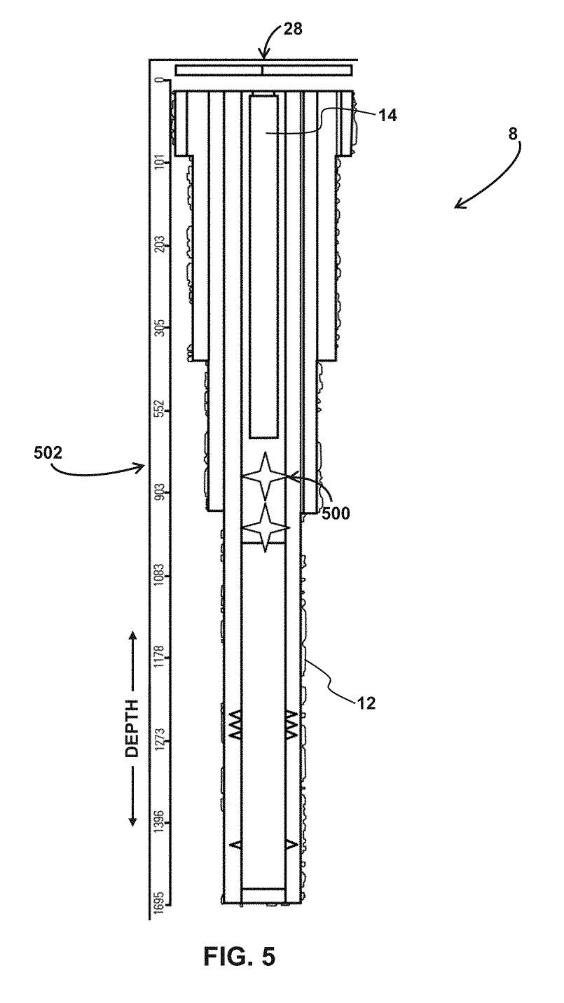

As shown in FIG. 5 and described above, the stimulus may be a propellant charge 500 and/or other similar stimuli. (It should be noted that propellant charges are used for wellbore completions, such as in casing perforation, but may or may not be an appropriate stimulus for an operating well, but it is used here as an example of a stimulus that produces a response from the components of well 8.) Stimulus 500 may occur at a given depth 502 in well 8. In the example shown in FIG. 5, stimulus 500 occurred within casing 12, but this is not intended to be limiting. A stimulus for well 8 may occur within casing 12 as shown in FIG. 5, within and/or along tube 14, at or near hanger 13, at, within, or near wellhead 28, in or near extraction equipment 16, and/or in other locations.

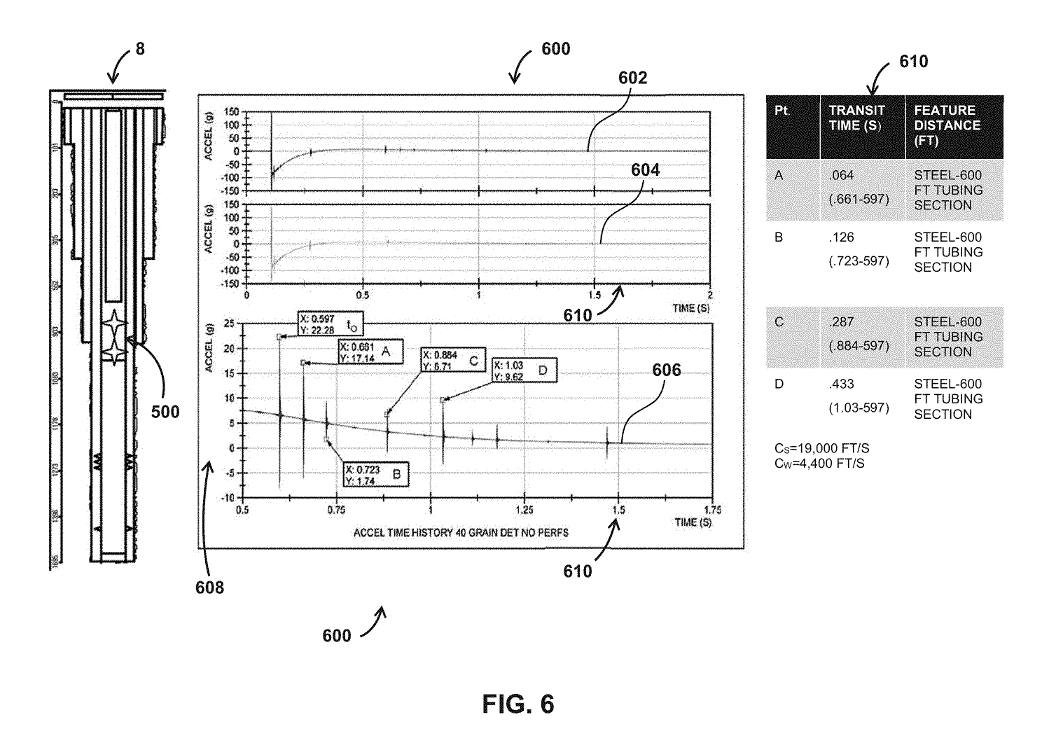

Stimulus 500 may produce a response from well 8. In some implementations, the response of a well 8 with an intact casing 12 and/or tube 14 may be different than the response of well 8 with a casing 12 and/or tube 14 that has suffered a structural integrity event. This is illustrated in FIG. 6-10. For example, FIG. 6 illustrates accelerations 600 detected in response to stimulus 500 occurring at depth 502 within casing 12 of well 8. FIG. 6 illustrates the response of an intact well 8 where no structural integrity events have occurred. FIG. 6 illustrates acceleration time history sensor output signals 602, 604, and 606 for acceleration 608 over time 610. Output signals 602 and 604 are from individual accelerations sensors (e.g., sensors 18 at different locations) in well 8, and/or from the same sensor after two repeated stimuli, and output signal 606 is an enlarged view of the information in such output signals. The scaling for signal 606 has been enlarged to show more detail. In some implementations, output signal 606 may be an enlarged view of either output signal 602 or output signal 604. In some implementations, output signal 606 may be an aggregation of information in output signals 602 and 604 from two or more individual sensors 18. As shown by signal 606, in response to stimulus 500 at time to, localized variations in acceleration occur at time points A, B, C, D, etc. These localized variations in acceleration are detected at different times 610 because they correspond to responses of different components of, and/or different locations in, well 8 to stimulus 500. The disturbance (e.g., the sound, vibrations, changes in a magnetic field, changes in pressure, changes in temperature, etc. as described herein) caused by stimulus 500 takes time to travel throughout well 8. Knowing, for example, the speed of sound through various media, facilitates determination by processor 20 of which well component and/or location has produced a given response A, B, C, D, etc. In this example, response A, detected after a 0.064 s transit time, was produced by a tubing section at a depth of 600 ft in well 8. Response B, detected after a 0.126 s transit time was produced by the casing at a depth of 960 ft. Responses C and D were produced by water at depths of 600 and 960 ft respectively. This is illustrated in Table 610 shown in FIG. 6. As described herein, and in relation to the example shown in FIG. 6, processor 20 (FIG. 1) may be configured to compare variations in acceleration 608 (e.g., amplitude, frequency, etc.) at time points A, B, C, D, etc. to variations in acceleration at the same time points in response to later repeated stimuli.

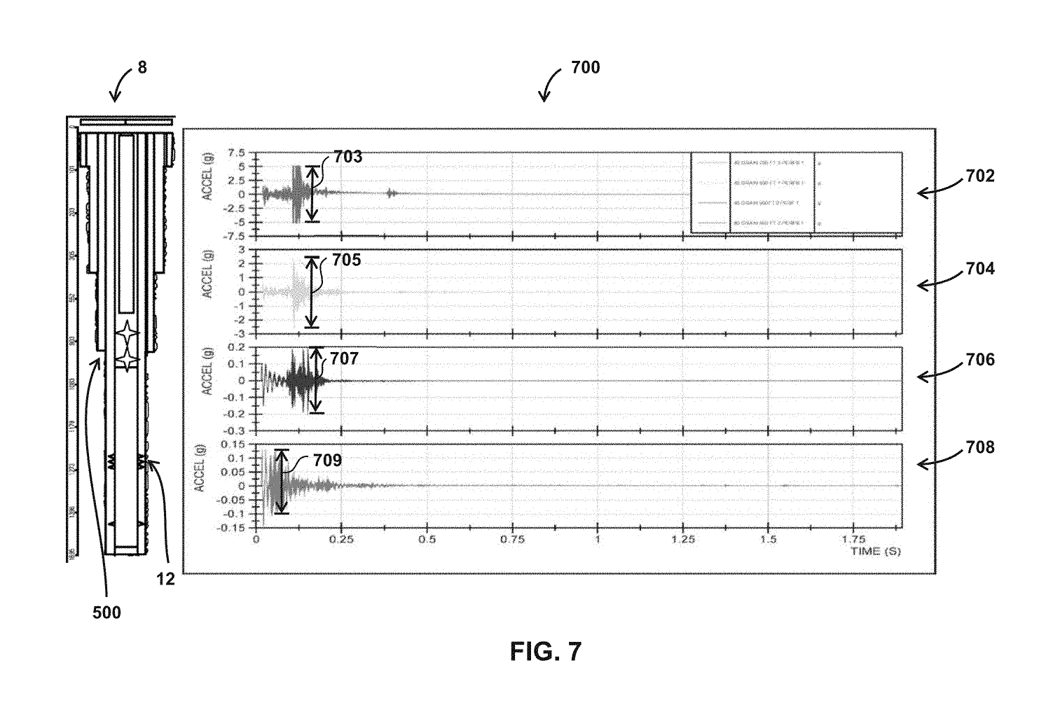

FIG. 7 illustrates the response of a well 8 that has experienced a plurality of structural integrity events. Structural defects were actively imparted onto the wellbore in the form of casing perforations, at a depth of 800′ and 900′. For example, FIG. 7 illustrates the acceleration response 700 (e.g., acceleration over time) for different components and/or at different depths 702, 704, 706, and 708 in well 8 to the same stimulus 500. As shown in FIG. 7, amplitudes 703 (about 10 g), 705 (about 4.5 g), 707 (about 0.4 g), and 709 (about 0.2 g) are generally smaller than acceleration response amplitudes shown at points A (about 20 g), B (about 5 g), C (about 5 g), and D (about 12 g) in FIG. 6. In some implementations, processor 20 (FIG. 1) is configured to detect structural integrity events based on such differences. For example, processor 20 may be configured to compare acceleration responses at an individual location, average accelerations across a plurality of locations, acceleration in combination with responses of other parameters of well 8 (e.g., as described herein), and/or other information from well 8 that indicates well 8 has suffered or is about to suffer a structural integrity event.

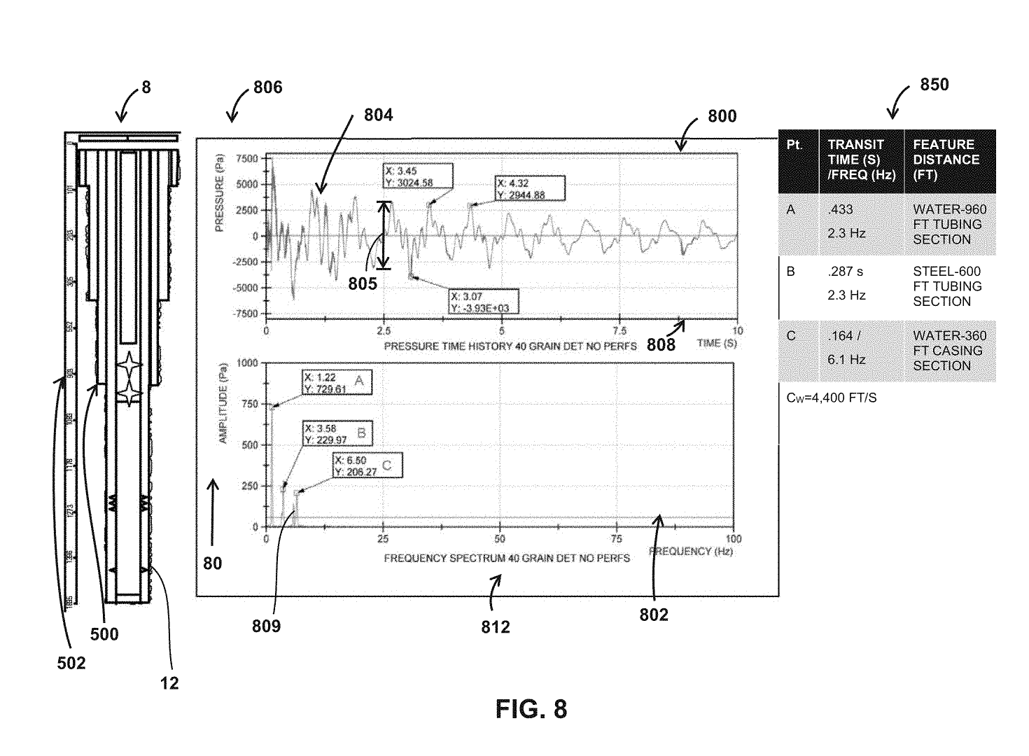

The illustration of acceleration in FIGS. 6 and 7 is not intended to be limiting. For example, FIG. 8 illustrates dynamic pressure 800 and resulting frequency spectrum 802 variation detected in response to stimulus 500 occurring at depth 502 within casing 12 of well 8 using hydrophone sensors located at surface. FIG. 8 illustrates the response of an intact well 8 where no structural integrity events have occurred. FIG. 8 illustrates dynamic pressure time history sensor output signal 804 for pressure 806 over time 808. FIG. 8 also illustrates output signal 809 showing the amplitudes 810 of a frequency spectrum 812 in response to stimulus 500. Output signals 804 and 809 may be from individual sensors (e.g., a pressure sensor 18, a hydrophone 18, etc.) in well 8, for example. As shown by signal 804, the amplitude 805 of pressure variation in response to stimulus 500 is about 7000 Pa. As shown by signal 809, in response to stimulus 500, localized peaks in frequency spectrum 812 appear at time points A, B, and C. These localized peaks are detected at different frequencies 812 because they correspond to responses of different components of, and/or different locations in, well 8 to stimulus 500. In this example, response A at about 2.3 Hz, detected after a 0.433 s transit time, was produced by a tubing section at a depth of 960 ft in well 8. Response B at about 3.5 Hz, detected after a 0.287 s transit time, was produced by a tubing section at a depth of 600 ft. Response C at about 6.1 Hz, detected after a 0.164 s transit time, was produced by the casing at a depth of 360 ft. This is illustrated in Table 850 shown in FIG. 8. As described herein, and in relation to the example shown in FIG. 8, processor 20 (FIG. 1) may be configured to compare current variations in pressure signal 804 (e.g., amplitude, frequency, etc.) and/or frequency spectrum signal 809 (e.g., frequency, intensity, etc.) to variations in these parameters in response to prior and/or later repeated stimuli.

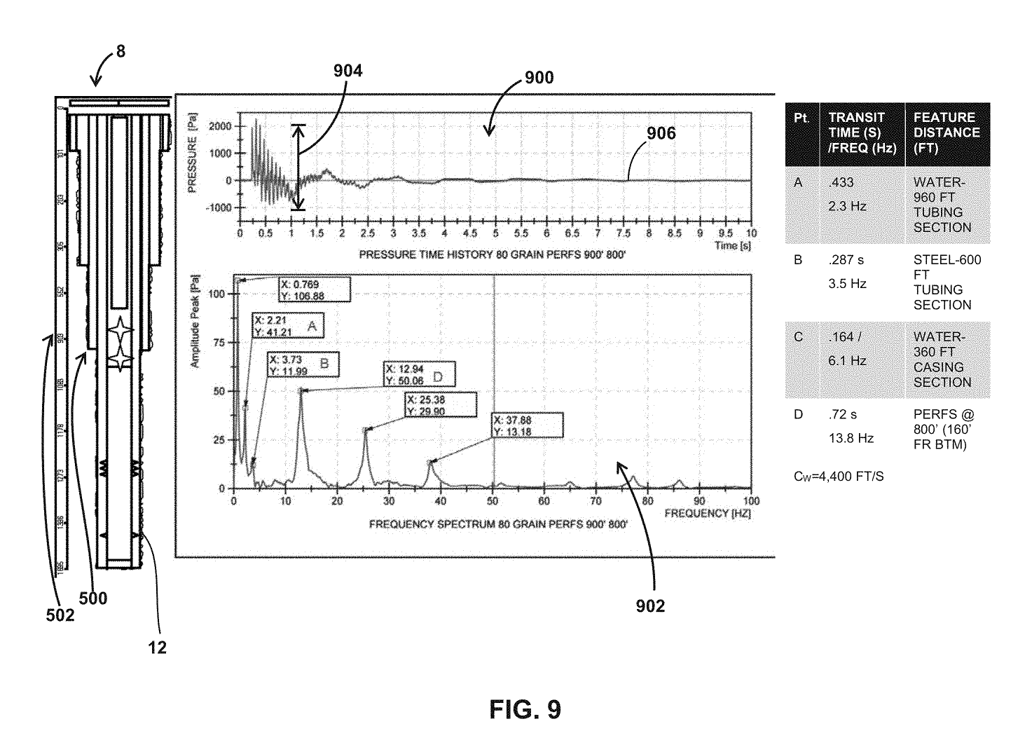

For example, FIG. 9 illustrates the pressure 900 and frequency spectrum 902 variation detected in response to the same stimulus for a well with structural integrity defects. Structural defects were actively imparted onto the wellbore in the form of casing perforations, at a depth of 800 and 900′. As shown in FIG. 9, the amplitude 903 (about 2500 Pa) of variations in pressure signal 906 is generally smaller than amplitude 805 (about 7000 Pa) in FIG. 8. In addition, amplitude 903 decreases to approximately zero in about 2.5s in FIG. 9. Signal 804 does not exhibit similar behavior in FIG. 8. Frequency spectrum signal 910 amplitude response peaks A (about 40 Pa) and B (about 4 Pa), are generally lower than corresponding peaks shown in FIG. 8 (ranging from about 200-700 Pa). A new peak at point D of the frequency spectrum, has appeared corresponding to the 800′ location of the imparted perforation defects. In some implementations, processor 20 (FIG. 1) is configured to detect structural integrity events based on such differences. For example, processor 20 may be configured to compare pressure and/or frequency spectrum responses at an individual location, average pressures and/or frequency spectrums across a plurality of locations, pressure and/or a frequency spectrum in combination with responses of other parameters of well 8 (e.g., as described herein), and/or other information from well 8 that indicates well 8 has suffered a structural integrity event.

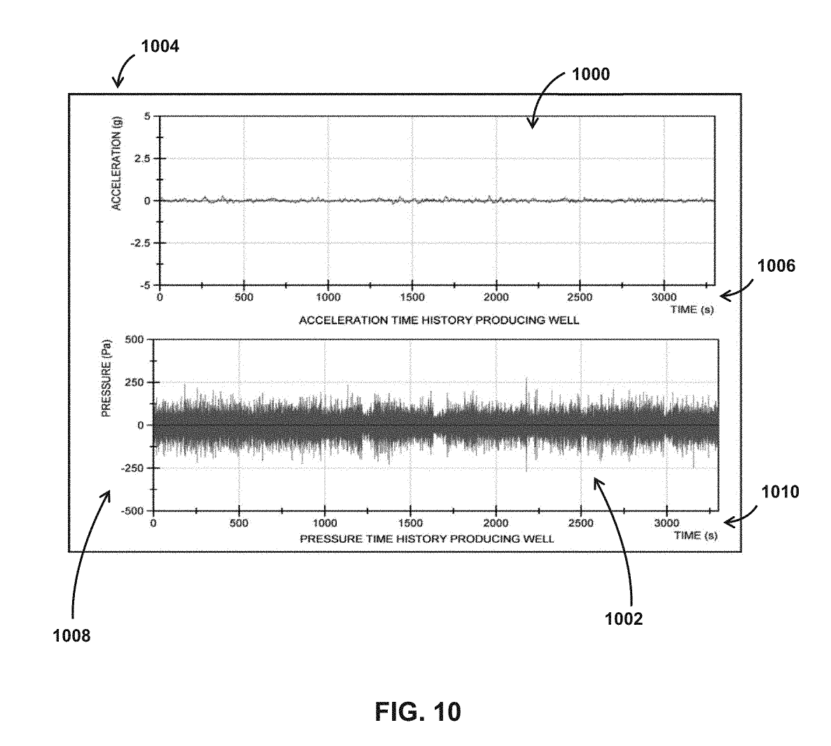

FIG. 10 illustrates an acceleration time history 1000 and a pressure time history 1002 for a producing well 8 (FIG. 1). In the example shown in FIG. 10, sensors 18 (FIG. 1) are passively monitoring well 8. No stimulus has been applied to well 8 in this example. However, as described above, the operation of well 8 may be a stimulus. As shown in FIG. 10, acceleration time history 1000 illustrates acceleration 1004 over time 1006. Pressure time history 1002 illustrates pressure 1008 over time 1010. These signals define a baseline normal operation of a well in a production phase, and determine the signal to noise ratio used to define threshold triggers, and other triggering parameters for user notification of off-normal conditions or wellbore structural integrity events. These signals are shown as examples only and are not intended to be limiting. For example, output signals from other sensor types, and/or from a non-producing well are contemplated. In some implementations, processor 20 (FIG. 1) may be configured to detect casing structural integrity events based on such information (as described herein). In this example, processor 20 may be configured to determine peak values in each signal and compare them to peak threshold values, determine overall root mean square (RMS) values for each signal and compare them to RMS threshold values, and or detect casing structural integrity events based on other operations.

In some implementations, processor 20 may be configured to detect the casing structural integrity events based on one or more algorithms. The one or more algorithms may be determined at manufacture, programmed, adjusted, uploaded, and/or updated by a user via user interface 22, and/or determined by other methods. Processor 20 may determine algorithm inputs based on the output signals. In some implementations, processor 20 may be configured such that the one or more algorithms may be configured to indicate whether well 8 is in a pre-production or a production phase, whether a casing structural integrity event has occurred and/or will occur, and/or other information. The one or more algorithms may be configured to indicate one or more structural integrity events occurring at one or more locations in casing 12. Algorithm inputs may include information conveyed by the output signals of sensors 18, baseline well information determined such as the one or more extraction parameters determined by processor 20, one or more well parameters determined by processor 20, and/or other inputs. As described above, the one or more well parameters may include, for example, a fluid level, a voltage and/or other electrical parameters, an acoustic parameter, a pressure, a motion parameter, a magnetic parameter, an acceleration parameter, an impedance parameter, a strain level, and/or other parameters. The one or more algorithms may be configured to account for how the well parameters may have different typical levels and/or corresponding thresholds for pre-production operation compared to production operation of well 8. Algorithm inputs may include currently determined information (e.g., the spectral character of current well acoustic signature in response to a stimulus) and/or previously determined information (e.g., the normal spectral character of well acoustic signature during pre-production and/or production operations, and/or the normal spectral character of well acoustic signature responsive to the same stimulus). In some implementations, the one or more algorithms may include and/or represent an electronic model of well 8. In some implementations, the electronic model may be a mathematical model. The mathematical model may include multi-dimensional model-based algorithms and/or other algorithms configured to interpret the output signals generated by sensors 18.

In some implementations, processor 20 may be configured to detect the casing structural integrity events based on the one or more algorithms, where processor 20 may be configured to determine algorithm inputs based on the output signals. In such implementations, processor 20 may determine the algorithm inputs such that the casing structural integrity events are detected based on information in output signals from one or more different types of sensors. In such implementations, the algorithm inputs may comprise well parameters (e.g., as described above), corresponding parameter threshold levels determined based on the output signals (e.g., as described below), and/or other inputs. In such implementations, the one or more algorithms may be configured such that, responsive to one or more of the well parameters breaching corresponding well parameter thresholds, output from the algorithm indicates that a casing structural integrity event has occurred.

By way of a non-limiting example, processor 20 may be configured to determine a fluid level in well 8, a strain level in tube 14, and the spectral character of acoustic signatures in well 8 based on the output signals generated by three different types of sensors 18. The fluid level, the strain level, and the spectral character of the acoustic signature may be algorithm inputs. Processor 20 may be configured such that an algorithm indicates that a structural integrity event is about to occur based on the fluid level, the strain level, and the spectral character inputs. In this example, processor 20 may not have detected the structural integrity event based on the fluid level, the strain level, and or the spectral character of the acoustic signature alone (e.g., by comparing one of these well parameters to a corresponding pre-production phase or production phase threshold level for that parameter). But as inputs to the algorithm, the fluid level, the strain level, and the spectral character of the acoustic signature together indicated the structural integrity event. The three types of information used in this example are not intended to be limiting. The algorithm may be configured to indicate structural integrity events based on any amount and/or type of input.

It should be noted that there are many possible physical phenomena (known and unknown), and/or many possible measurements that may be made by current and future sensor technology, during an actual casing or tubing structural failure event. Such events may occur suddenly, releasing large amounts of energy in a short duration of time, or may occur gradually. For at least this reason, it is envisioned that structural health monitoring of wellbores is a task that could include many possible monitoring and data analysis techniques. As discussed, such approaches include passive and/or active monitoring of wellbores. Passive monitoring entails gathering various sensor data from active wells without application of any additional stimuli. Active monitoring entails applying an active stimulus, such a propellant charge, onto components of an active well and gathering sensor data of the well's response to the applied stimuli. These methods can be utilized to determine if a structural integrity issue exists or occurs within a wellbore as follows (as described herein). As an example, in practical application, an initial assessment of well(s) under consideration may be conducted with active monitoring. The initial assessment, conducted by active acoustic stimulation (for example), may determine whether any structural anomalies exist by the stimulus-response techniques previously discussed. If anomalies exist and are verified with traditional well surveys (for example), then remedial action may be taken, such as repair or abandonment of the well. If no anomalies are indicated and verified, the well can be considered in normal operation and passive monitoring can commence. Passive monitoring of the one or more well parameters may include, for example, a fluid level, a voltage and/or other electrical parameters, an acoustic parameter, a pressure, a temperature, a motion parameter, a magnetic parameter, an acceleration parameter, an impedance parameter, a strain level, and/or other parameters. The initial monitoring of the well(s) will yield data that represents a normally operating condition and may be used as a baseline for comparison. Machine learning algorithms may be developed to gather these baseline conditions for all phases of a well's operation, and used as a basis for determination of any abnormal physical (structural integrity) events that are detected by the various sensors. Abnormal physical events verified by a secondary method (such as the active acoustic stimulation or wireline well logging) may be confirmed structural failures and archived by the algorithm for use in autonomous identification of similar events, (i.e. signal filtering, pattern recognition and machine learning). As the library of both the normal operation and verified structural failure data grows, so will the confidence in not only determining if a casing breach exists but possibly prediction of casing failures before the occur.

In some implementations, processor 20 may be configured to cluster the information conveyed by the output signals. Processor 20 may be configured to detect the casing structural integrity events based on the clustering. Clustering may comprise arranging the information conveyed by the output signals in a multidimensional space. Arranging the information in the multidimensional space may comprise grouping the information conveyed by the output signals of sensors 18 into separate data clusters based on similarities in the information conveyed by the output signals. Similarities in the data may indicate, for example, that well 8 is operating normally. In some implementations, processor 20 may be configured to cluster information conveyed by the output signals of sensors 18 that indicates well 8 is operating normally into a first data cluster and information that indicates a casing structural integrity event into one or more additional data clusters. The information conveyed by the output signals of sensors 18 may be clustered by processor 20 based on statistical similarities in the information, magnitudes and/or directions of vectors that represent the information in the multidimensional space, and/or other information. Clustering may be known as networking in some implementations.

In some implementations, processor 20 may be configured to generate casing structural integrity scores based on the output signals. Processor 20 may be configured to detect the casing structural integrity events based on the casing structural integrity scores. In some implementations, the casing structural integrity scores may be individual values related to individual structural integrity events. In some implementations, the casing structural integrity scores may be individual values that indicate a likelihood that a structural integrity event has occurred and/or will occur. In some implementations, processor 20 may be configured such that the casing structural integrity scores comprise weighted structural integrity scores. A weighted structural integrity score may comprise a collection of individually weighted scores based on information conveyed by the output signals from individual ones of the different types of sensors 18 (e.g., fluid level, strain, etc.) The individually weighted scores may be weighted based on individual relationships between the information conveyed by the output signals from specific sensors 18 and whether that information has more or less importance relative to a specific casing structural integrity event. Processor 20 may be configured to determine the importance of the information conveyed by the output signals from specific sensors 18 based on input from user interface 22, information determined at manufacture, and/or other information.

User interface 22 may be configured to facilitate delivery of casing structural integrity event notifications generated by processor 20 and/or other information to users. User interface 22 may be configured to receive entry and/or selection of information from users. User interface 22 may be configured to receive entry and/or selection of control inputs from users that facilitate operation of well 8 such that the users may adjust and/or cease the operation of well 8 if necessary, responsive to receiving casing structural integrity event notifications. Users may include well site managers, remote operators, petroleum engineers, and/or other users. This enables data, cues, results, notifications, instructions, and/or any other communicable items, collectively referred to as “information,” to be communicated between users and processor 20, extraction equipment 16, and/or other components of system 10. Examples of interface devices suitable for inclusion in user interface 22 comprise a keypad, buttons, switches, a keyboard, knobs, levers, a display screen, a touch screen, speakers, a microphone, an indicator light, an audible alarm, a printer, a tactile feedback device, and/or other interface devices. In some implementations, user interface 22 comprises a plurality of separate interfaces. In some implementations, user interface 22 comprises at least one interface that is provided integrally with processor 20 and/or extraction equipment 16.

It is to be understood that other communication techniques, either hard-wired or wireless, are also contemplated by the present disclosure as user interface 22. For example, the present disclosure contemplates that user interface 22 may be integrated with a removable electronic storage interface disposed in extraction equipment 16. In this example, information may be loaded into system 10 from removable storage (e.g., a smart card, a flash drive, a removable disk, etc.) that enables the user(s) to customize the implementation of system 10. Other exemplary input devices and techniques adapted for use with system 10 as user interface 22 comprise, but are not limited to, an RS-232 port, RF link, an IR link, modem (telephone, cable or other). In short, any technique for communicating information with system 10 is contemplated by the present disclosure as user interface 22.

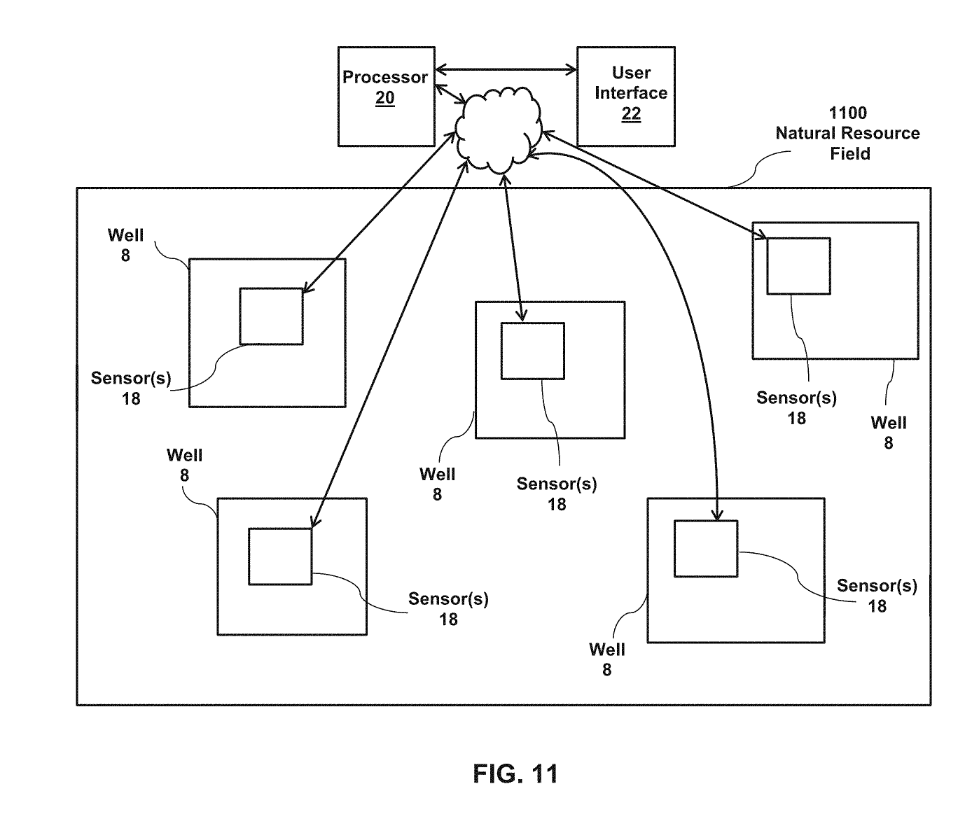

FIG. 11 illustrates a natural resource field 1100 that includes multiple wells 8. Sensors 18 and/or the other components of system 10 may be located at the individual wells 8 and generate output signals conveying information related to the structural integrity of the casings of the individual wells 8 to processor 20. Such an arrangement of sensors 18 and/or wells 8 in natural resource field 1100 may facilitate mapping geologic behavior of field 1100. Geologic behavior may include, for example, geologic movement, temperature changes, pressure changes, satellite provided geologic data, GPS data, and/or other geologic behavior. In some implementations, the information generated for each well 8 may be time synchronized by processor 20 such that geologic events may be detected and/or predicted in the areas of natural resource field 1100 that are not directly instrumented. Notifications related to the geologic behavior of natural resource field 1100 may be generated by processor 20 for delivery to a user via user interface 22, for example.

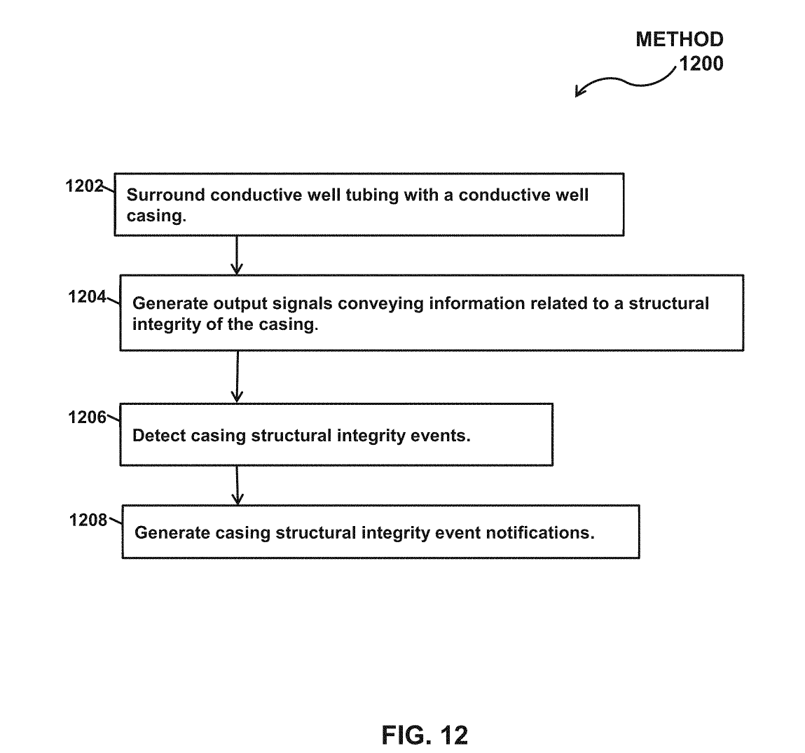

FIG. 12 illustrates a method 1200 for detecting structural integrity of a well casing in a well. The operations of method 1200 presented below are intended to be illustrative. In some implementations, method 1200 may be accomplished with one or more additional operations not described, and/or without one or more of the operations discussed. Additionally, the order in which the operations of method 1200 are illustrated in FIG. 12 and described herein is not intended to be limiting.

In some implementations, method 1200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1200 in response to instructions stored electronically on one or more electronic storage mediums. The one or more processing devices may include one or more devices configured through hardware, firmware, and/or software to be specifically designed for execution of one or more of the operations of method 1200.

At an operation 1202, conductive well tubing may be surrounded with a conductive well casing. The tubing may be configured to communicate liquid and/or gas from an underground reservoir to above ground extraction equipment at a wellhead. In some implementations, the tubing may be a tubing string. The casing may be embedded in a geologic structure. In some implementations, operation 1202 may be performed by a well casing the same as or similar to casing 12 (shown in FIG. 1 and described herein).

At an operation 1204, output signals conveying information related to a structural integrity of the casing may be generated. The output signals may be generated with one or more sensors. In some implementations, the one or more sensors may include one or more sensor types. In some implementations, the one or more sensors may include two or more sensor types. The sensor types may include fluid level sensors, voltage sensors, acoustic sensors, pressure sensors, motion sensors, strain sensors, and/or other sensors. The sensors may be located at various locations in and/or near the well. At least one of the sensors may be electrically coupled with the well tubing and the well casing separately. At least one of the sensors may be located in the wellhead. The one or more sensors may be located at one or more locations along the tubing within the casing. The one or more sensors may be located within the well casing at or near a tubing hanger between the wellhead and the well tubing. The tubing hanger may be configured to suspend the tubing in the casing. In some implementations, operation 1204 may be performed by sensors the same as or similar to sensors 18 (shown in FIG. 1 and described herein).

At an operation 1206, casing structural integrity events may be detected. The casing structural integrity events may be detected based on the output signals. The casing structural integrity events may be detected responsive to one or more forces acting on the well casing. The one or more forces may include a shear force, a tensile force, and a compressive force, a torsional force, and/or other forces. The one or more forces may be generated by the geologic structure surrounding the casing.

In some implementations, extraction parameters may be determined at operation 1206. The extraction parameters may be determined based on the output signals and/or other information. Detecting the well casing structural integrity events may be based on the extraction parameters. The extraction parameters may include information indicating whether the well is operating in a production phase or a pre-production phase. In some implementations, the casing structural integrity events may be detected based on an algorithm. The algorithm inputs may be determined based on the output signals. In some implementations, at operation 1206, the information conveyed by the output signals may be clustered and/or networked. Detecting the casing structural integrity events may be based on the clustering. Clustering may comprise arranging the information conveyed by the output signals in a multidimensional space. In some implementations, at operation 1206, casing structural integrity scores may be generated based on the output signals. Detecting the casing structural integrity events may be based on the casing structural integrity scores. In some implementations, at operation 1206, one or more well parameters may be determined based on the output signals. The one or more well parameters may include one or more of a fluid level, a voltage, an acoustic parameter, a pressure, a motion parameter, a strain level, and/or other parameters. Well parameter threshold levels may be determined and the casing structural integrity events may be detected responsive to the well parameters breaching the well parameter threshold levels. For example, a first casing structural integrity event may be detected responsive to a first well parameter breaching a first well parameter threshold level.

In some implementations, operation 1206 may be performed by a processor the same as or similar to processor 20 (shown in FIG. 1 and described herein).

At an operation 1208, casing structural integrity event notifications that correspond to the detected casing structural integrity events may be generated. The notifications may be generated for delivery to a user responsive to the detections. The well casing structural integrity events may include one or both of structural failures of the casing and/or potential structural failures of the casing. In some implementations, operation 1208 may be performed by a processor the same as or similar to processor 20 (shown in FIG. 1 and described herein).

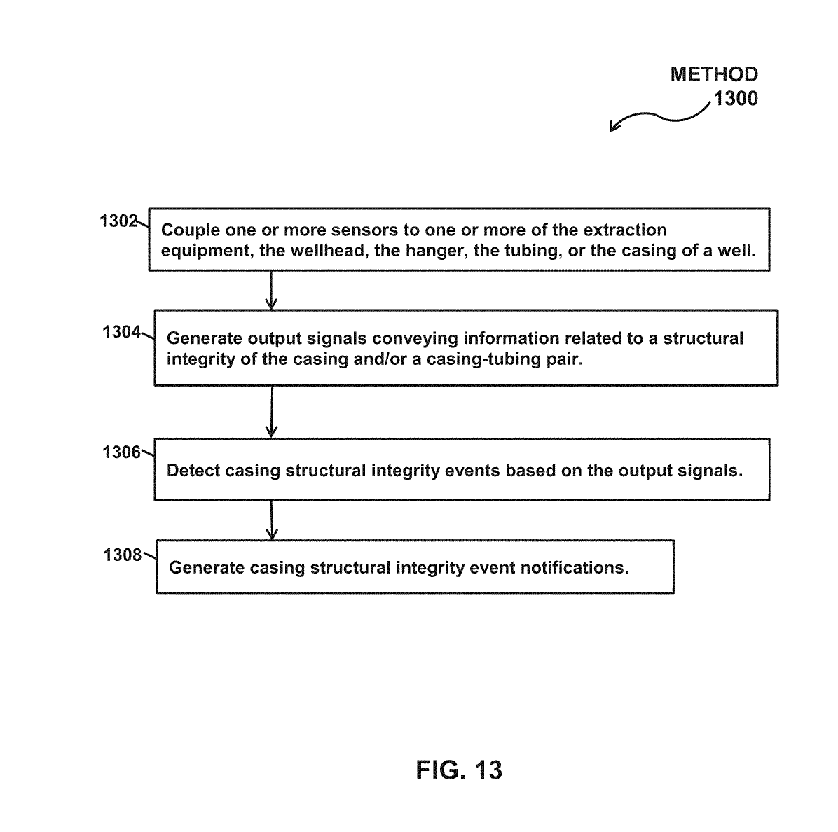

FIG. 13 illustrates a method 1300 for detecting structural integrity of a well casing in a well with a detection system. The well comprises a wellhead at a ground surface of the well, and above ground extraction equipment located at or near the wellhead. The extraction equipment may be configured to extract liquid and/or gas from an underground reservoir through the wellhead. The system comprises a conductive well casing configured to surround conductive well tubing. The tubing may be configured to communicate the liquid and/or gas from the underground reservoir to the above ground extraction equipment. The casing may be embedded in a geologic structure. The well comprises a hanger coupled to the wellhead. The hanger may be configured to suspend the tubing within the casing. The system comprises one or more sensors, one or more processors, and/or other components. The operations of method 1300 presented below are intended to be illustrative. In some implementations, method 1300 may be accomplished with one or more additional operations not described, and/or without one or more of the operations discussed. Additionally, the order in which the operations of method 1300 are illustrated in FIG. 13 and described herein is not intended to be limiting.

In some implementations, method 1300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1300 in response to instructions stored electronically on one or more electronic storage mediums. The one or more processing devices may include one or more devices configured through hardware, firmware, and/or software to be specifically designed for execution of one or more of the operations of method 1300.

At an operation 1302, one or more of the sensors may be coupled to one or more of the extraction equipment, the wellhead, the hanger, the tubing, or the casing. In some implementations, operation 1302 includes coupling a first accelerometer, a first hydrophone, and a first strain gage to the hanger; coupling a second accelerometer and a pressure gage to the tubing and/or casing in the well below the hanger; and coupling a second hydrophone, a third accelerometer, and a magnetometer to the wellhead and/or the extraction equipment. In some implementations, operation 1302 may be performed by one or more sensors the same as or similar to sensors 18 (shown in FIG. 1 and described herein).

At an operation 1304, output signals conveying information related to a structural integrity of the casing and/or of the casing-tubing pair may be generated. The output signals may be generated with the one or more sensors. The output signals may be generated by one or more of fluid level sensors, voltage sensors, acoustic sensors, pressure sensors, motion sensors, current sensors, impedance sensors, magnetic sensors, strain sensors, and/or other sensors. For example, the output signals may be generated by one or more hydrophones, one or more electrical impedance sensors, one or more magnetometers, one or more accelerometers, one or more strain gages, one or more pressure gages, and/or one or more other sensors. In some implementations, the information related to the structural integrity of the casing and/or the casing-tubing pair may comprise information indicating a response of the tubing, the casing, the liquid, and/or the gas of the well to a stimulus generated for the well. In some implementations, the response may be an acoustic response, and the casing structural integrity events are determined based on a speed of sound caused by the stimulus through one or more of the tubing, the casing, the liquid, or the gas. The stimulus may comprise pre-production phase operation of the well, production phase operation of the well, a propellant charge, an electromagnetic stimulus, a pneumatic stimulus, and/or other stimuli. In some implementations, operation 1304 may include generating output signals for two or more separate stimuli generated during either a pre-production phase or a production phase of well operation. In some implementations, operation 1304 may be performed by sensors the same as or similar to sensors 18 (shown in FIG. 1 and described herein).

At an operation 1306, casing structural integrity events may be detected. The casing structural integrity events may be detected based on the output signals. The casing structural integrity events may be detected responsive to one or more forces acting on the well casing. The casing structural integrity events may be detected based on a comparison of information in output signals corresponding to two or more separate stimuli generated at different times for the well. The information in the output signals corresponding to the two or more separate stimuli generated for the well may comprise one or both of time histories for given output signals or frequency spectrums for the given output signals, and/or other information. In some implementations, operation 1306 includes detecting the casing structural integrity events based on an algorithm. Algorithm inputs may be determined based on the output signals such that the casing structural integrity events are detected based on information in output signals from one or more different types of sensors. Algorithm inputs may comprise well parameters and corresponding parameter threshold levels determined based on the output signals. In some implementations, responsive to one or more of the well parameters breaching corresponding well parameter thresholds, output from the algorithm indicates that a casing structural integrity event has occurred. In some implementations, operation 1306 may be performed by a processor the same as or similar to processor 20 (shown in FIG. 1 and described herein).

At an operation 1308, casing structural integrity event notifications that correspond to the detected casing structural integrity events may be generated. The notifications may be generated for delivery to a user responsive to the detections. The well casing structural integrity events may include one or both of structural failures of the casing and/or potential structural failures of the casing. In some implementations, operation 1308 may be performed by a processor the same as or similar to processor 20 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to detect structural integrity of a well casing in a well, the well comprising a wellhead at a ground surface of the well, above ground extraction equipment located at or near the wellhead, the extraction equipment configured to extract liquid and/or gas from an underground reservoir through the wellhead, a conductive well casing configured to surround conductive well tubing, the tubing being configured to communicate the liquid and/or gas from the underground reservoir to the above ground extraction equipment, the casing being embedded in a geologic structure, and a hanger coupled to the wellhead, the hanger configured to suspend the tubing within the casing, the system comprising:
one or more sensors configured to generate output signals conveying information related to a structural integrity of the casing and/or a casing-tubing pair, wherein:
the one or more sensors are coupled to one or more of the extraction equipment, the wellhead, the hanger, the tubing, or the casing; and
the information related to the structural integrity of the casing and/or the casing-tubing pair comprises information indicating a response of the tubing, the casing, the liquid, and/or the gas of the well to a stimulus generated for the well; and
one or more processors configured to detect casing structural integrity events based on the output signals, and to generate casing structural integrity event notifications that correspond to the detected casing structural integrity events for delivery to a user, the casing structural integrity events including one or both of structural failures of the casing or potential structural failures of the casing.

2. The system of claim 1, wherein the one or more sensors and the one or more processors are configured such that the stimulus comprises pre-production phase operation of the well, production phase operation of the well, a propellant charge, an electromagnetic stimulus, or a pneumatic stimulus.

3. The system of claim 1, wherein the one or more processors are further configured to detect the casing structural integrity events based on a comparison of information in output signals corresponding to two or more separate stimuli generated at different times for the well.

4. The system of claim 3, wherein the one or more sensors are configured such that the information in the output signals corresponding to the two or more separate stimuli generated for the well comprises one or both of time histories for given output signals or frequency spectrums for the given output signals.

5. The system of claim 3, wherein the one or more sensors are configured to generate output signals for two or more separate stimuli generated during either a pre-production phase or a production phase of well operation.

6. The system of claim 1, wherein the one or more processors are configured to detect the casing structural integrity events based on an algorithm, wherein the one or more processors determine algorithm inputs based on the output signals such that the casing structural integrity events are detected based on information in output signals from one or more different types of sensors, wherein the algorithm inputs comprise well parameters and corresponding parameter threshold levels determined based on the output signals, and wherein, responsive to one or more of the well parameters breaching corresponding well parameter thresholds, output from the algorithm indicates that a casing structural integrity event has occurred.

7. The system of claim 1, wherein the one or more sensors include one or more of fluid level sensors, voltage sensors, acoustic sensors, pressure sensors, temperature sensors, motion sensors, current sensors, impedance sensors, magnetic sensors, and strain sensors.

8. The system of claim 7, wherein the one or more sensors include one or more hydrophones, one or more electrical impedance sensors, one or more magnetometers, one or more accelerometers, one or more strain gages, and one or more pressure gages.

9. The system of claim 8, wherein a first accelerometer, a first hydrophone, and a first strain gage are coupled to the hanger; a second accelerometer and a pressure gage are coupled to the tubing and/or casing in the well below the hanger; and a second hydrophone, a third accelerometer, and a magnetometer are coupled to the wellhead and/or the extraction equipment.

10. The system of claim 1, wherein the one or more sensors are configured such that the response is an acoustic response, and wherein the one or more processors are configured such that casing structural integrity events are determined based on a speed of sound caused by the stimulus through one or more of the tubing, the casing, the liquid, or the gas.

11. The system of claim 1, wherein the one or more sensors and the one or more processors are configured such that generating the information indicating the response of the tubing, the casing, the liquid, and/or the gas of the well to the stimulus generated for the well, and detecting the casing structural integrity events based on the information indicating the response of the tubing, the casing, the liquid, and/or the gas of the well to the stimulus comprises active monitoring, and
wherein the one or more sensors and the one or more processors are further configured to passively monitor the tubing, the casing, the liquid, and/or the gas of the well, passive monitoring comprising generating information about the tubing, the casing, the liquid, and/or the gas of the well in an absence of the stimulus, and detecting the casing structural integrity events based on the information about the tubing, the casing, the liquid, and/or the gas of the well in the absence of the stimulus.

12. The system of claim 1, wherein the well comprises a steam injection well, wherein the one or more sensors generate output signals conveying information related to steam parameters including one or more of fluid velocity, temperature, pressure, or specific volume of the steam, and
wherein the one or more processors are configured to:
use a steam mass flow rate determination methodology based on the information in the sensor output signals from sensors located at a surface inlet of the well and a formation outlet of the well to determine a mass flow rate of steam flowing through the well at the inlet of the well and at the outlet of the well, and
detect casing structural integrity events responsive to the mass flow rate at the surface inlet and the mass flow rate at the formation outlet not being substantially equal.

13. A method for detecting structural integrity of a well casing in a well with a detection system, the well comprising a wellhead at a ground surface of the well, above ground extraction equipment located at or near the wellhead, the extraction equipment configured to extract liquid and/or gas from an underground reservoir through the wellhead, a conductive well casing configured to surround conductive well tubing, the tubing being configured to communicate the liquid and/or gas from the underground reservoir to the above ground extraction equipment, the casing being embedded in a geologic structure, and a hanger coupled to the wellhead, the hanger configured to suspend the tubing within the casing, the system comprising one or more sensors, and one or more processors, the method comprising:
coupling the one or more sensors to one or more of the extraction equipment, the wellhead, the hanger, the tubing, or the casing;
generating, with the one or more sensors, output signals conveying information related to a structural integrity of the casing and/or a casing-tubing pair, the information related to the structural integrity of the casing and/or the casing-tubing pair comprising information indicating a response of the tubing, the casing, the liquid, and/or the gas of the well to a stimulus generated for the well;
detecting, with the one or more processors, casing structural integrity events based on the output signals, and
generating casing structural integrity event notifications that correspond to the detected casing structural integrity events for delivery to a user, the casing structural integrity events including one or both of structural failures of the casing or potential structural failures of the casing.

14. The method of claim 13, wherein the stimulus comprises pre-production phase operation of the well, production phase operation of the well, an propellant charge, an electromagnetic stimulus, or a pneumatic stimulus.

15. The method of claim 13, further comprising detecting the casing structural integrity events based on a comparison of information in output signals corresponding to two or more separate stimuli generated at different times for the well.

16. The method of claim 15, wherein the information in the output signals corresponding to the two or more separate stimuli generated for the well comprises one or both of time histories for given output signals or frequency spectrums for the given output signals.

17. The method of claim 15, further comprising generating output signals for two or more separate stimuli generated during either a pre-production phase or a production phase of well operation.

18. The method of claim 13, further comprising detect the casing structural integrity events based on an algorithm, wherein algorithm inputs are determined based on the output signals such that the casing structural integrity events are detected based on information in output signals from one or more different types of sensors, wherein the algorithm inputs comprise well parameters and corresponding parameter threshold levels determined based on the output signals, and wherein, responsive to one or more of the well parameters breaching corresponding well parameter thresholds, output from the algorithm indicates that a casing structural integrity event has occurred.

19. The method of claim 13, wherein the output signals are generated by one or more of fluid level sensors, voltage sensors, acoustic sensors, pressure sensors, motion sensors, current sensors, impedance sensors, magnetic sensors, or strain sensors.

20. The method of claim 19, wherein the output signals are generated by one or more hydrophones, one or more electrical impedance sensors, one or more magnetometers, one or more accelerometers, one or more strain gages, and/or one or more pressure gages.

21. The method of claim 20, further comprising coupling a first accelerometer, a first hydrophone, and a first strain gage to the hanger; coupling a second accelerometer and a pressure gage to the tubing and/or casing in the well below the hanger; and coupling a second hydrophone, a third accelerometer, and a magnetometer to the wellhead and/or the extraction equipment.

22. The method of claim 13, wherein the response is an acoustic response, and wherein the casing structural integrity events are determined based on a speed of sound caused by the stimulus through one or more of the tubing, the casing, the liquid, or the gas.

23. The method of claim 13, wherein generating the information indicating the response of the tubing, the casing, the liquid, and/or the gas of the well to the stimulus generated for the well, and detecting the casing structural integrity events based on the information indicating the response of the tubing, the casing, the liquid, and/or the gas of the well to the stimulus comprises active monitoring,
the method further comprising passively monitoring the tubing, the casing, the liquid, and/or the gas of the well with the one or more sensors and the one or more processors, passive monitoring comprising generating information about the tubing, the casing, the liquid, and/or the gas of the well in an absence of the stimulus, and detecting the casing structural integrity events based on the information about the tubing, the casing, the liquid, and/or the gas of the well in the absence of the stimulus.

24. The method of claim 13, wherein the well comprises a steam injection well, wherein the one or more sensors generate output signals conveying information related to steam parameters including one or more of fluid velocity, temperature, pressure, or specific volume of the steam, and
wherein the method further comprises:
using a steam mass flow rate determination methodology based on the information in the sensor output signals from sensors located at a surface inlet of the well and a formation outlet of the well to determine a mass flow rate of steam flowing through the well at the inlet of the well and at the outlet of the well, and
detecting casing structural integrity events responsive to the mass flow rate at the surface inlet and the mass flow rate at the formation outlet not being substantially equal.
